(19) United States
(12) Patent Application Publication
(10) Pub. No.: US 2026/0039176 A1
(43) Pub. Date: Feb. 5, 2026

(54) ROTARY SOLENOID ACTUATOR

(71) Applicant: SAIA-BURGESS LLC, VANDALIA, OH (US)

(72) Inventors: Luke VOGT, West Milton, OH (US); James C. IRWIN, Beavercreek, OH (US); James M. GRUDEN, Centerville, OH (US)

(21) Appl. No.: 19/351,996

(22) Filed: Oct. 7, 2025

Related U.S. Application Data
(63) Continuation of application No. PCT/US2023/018292, filed on Apr. 12, 2023.

(51) Int. Cl. H02K 26/00; H02K 1/276; H02K 5/173

(52) U.S. Cl. CPC H02K 26/00; H02K 1/2773; H02K 5/1732; H02K 2201/03; H02K 2213/03

(57) ABSTRACT

A rotary solenoid actuator is provided. The rotary solenoid actuator includes a rotor assembly surrounded by a stator and solenoid housing, the rotor assembly including a rotor body with internally mounted magnets that are disposed radially inwards from an outer surface of the rotor body. The rotary solenoid also includes the use of concentricity locating features that provide small tolerance capability between the rotor body and the stator. In this rotary solenoid, the bearing containment assemblies locate to the pole faces of the stator such that the rotor assembly is guaranteed to be concentric to the stator assembly ensuring the ability to maintain a small air gap between the rotor body and the stator.

### CROSS REFERENCE TO RELATED APPLICATIONS

This non-provisional patent application is a continuation application of PCT Application No. PCT/US2023/018292, filed with the USPTO on Apr. 12, 2023, which is incorporated herein by reference in its entirety.

### FIELD OF THE INVENTION

The present disclosure relates generally to a rotary solenoid actuator, and more particularly to a rotary solenoid actuator having a narrow air gap.

### BACKGROUND

In the design and manufacturing of rotary solenoids, the internal rotors of these solenoids are typically magnetized via surface permanent magnets that are mounted on outer surface of the rotor. While the use of these surface mounted permanent magnets negates the need for laminated rotors and makes the manufacturing process simpler, the manufacturing tolerances of the surface magnets introduces constraints on the functionality of the rotary solenoid. One such constraint is on the size of the air gap that can be achieved between the rotor and the stator. Small air gaps are desirable for high-speed actuation cases. However, to achieve these small air gaps, a high degree of concentricity and tight tolerances on the relative size of the rotor and the stator is needed. The tolerance available for magnets (such as the magnets used for the permanent surface magnets) are typically higher than desired when trying to achieve the size of air gaps necessary for rapid actuation of the solenoid. An inability to maintain tight concentricity of the rotor and stator also makes it difficult to achieve the desired size of air gaps. There is a need for a design of a rotary solenoid that maintains a high degree of concentricity between the rotor and stator and provides a tight tolerance for the size of the air gap between the rotor and the stator. It is therefore an object of the present disclosure to provide a novel rotary solenoid actuator.

### SUMMARY OF THE INVENTION

According to an aspect, there is provided a rotary solenoid actuator comprising a rotor assembly including a rotor body mounted on a rotor shaft, the rotor body including a plurality of cavities which extend along a length of the rotor body and which are spaced radially inwards from a radially outer surface of the rotor body, each of the plurality of cavities including a permanent magnet mounted therewithin, a solenoid housing including opposingly disposed first and second bearing containment assemblies, each of the first and second bearing containment assemblies rotatably supporting an end of the rotor shaft, and a stator surrounding the at least the rotor body of the rotor assembly.

According to another aspect, there is provided a rotary solenoid actuator comprising a rotor assembly including a rotor body mounted on a rotor shaft, a solenoid housing including first and second end housing members, each of the first and second end housing members including a bearing containment assembly that rotatably supports an end of the rotor shaft, a stator surrounding the rotor assembly and including a plurality of through-apertures extending along a length thereof, at least one securing element being connected to the stator and extending between the first and second end housing members for axially securing the stator between the first and second end housing members, a plurality of alignment elements, each of the plurality of alignment elements being received through one of the plurality of through-apertures and being connected to each of the first and second end housing members, the plurality of through-apertures being formed such that when stator is axially secured between the first and second end housing members and the plurality of alignment elements are received through the plurality of through-apertures, the stator is secured in concentric alignment with the first and second housing members.

### BRIEF DESCRIPTION OF THE DRAWINGS

Embodiments will now be described, by way of example only, with reference to the attached Figures, wherein:

FIG. 1A shows an isometric view of an embodiment of the rotary solenoid according to the present disclosure, where the rotor body includes internal permanent magnets;

FIG. 1B shows a perspective view of the embodiment of the rotary solenoid of FIG. 1A;

FIG. 1C shows a side view of the embodiment of the rotary solenoid of FIG. 1A;

FIG. 1D shows a front view of the embodiment of the rotary solenoid of FIG. 1A;

FIG. 2 shows a section view of the embodiment of the rotary solenoid of FIG. 1D along the section line V2;

FIG. 3 shows a section view of the embodiment of the rotary solenoid of FIG. 1C along the section line V1;

FIG. 4 shows a close-up view of the embodiment of the rotor poles as provided in FIG. 3;

FIG. 5A shows an isometric view of an additional embodiment of the rotary solenoid, where the rotary solenoid includes alignment elements and corresponding through-apertures;

FIG. 5B shows a perspective view of the embodiment of the rotary solenoid of FIG. 5A;

FIG. 5C shows a side view of the embodiment of the rotary solenoid of FIG. 5A;

FIG. 5D shows a front view of the embodiment of the rotary solenoid of FIG. 5A;

FIG. 6 shows a section view of the embodiment of the rotary solenoid of FIG. 5C along the section line V3;

FIG. 7 shows a section view of the embodiment of the rotary solenoid of FIG. 5D along the section line V5;

FIG. 8 shows a section view of the embodiment of the rotary solenoid of FIG. 5D along the section line V4; and

FIG. 9 shows an exploded view of the embodiment of the rotary solenoid of FIG. 1A.

### DETAILED DESCRIPTION OF THE PREFERRED EMBODIMENTS

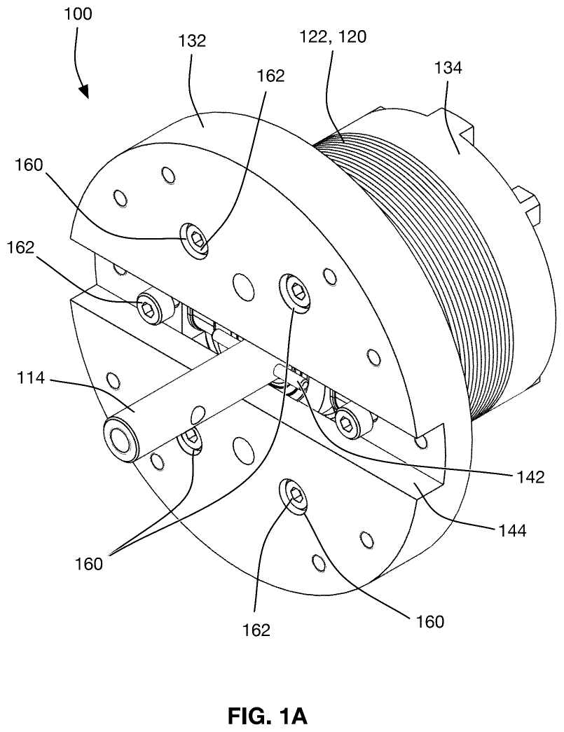

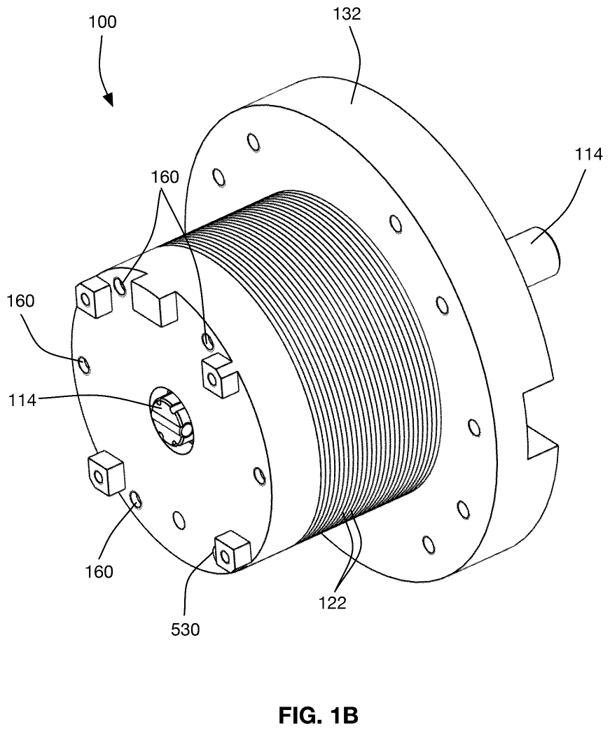

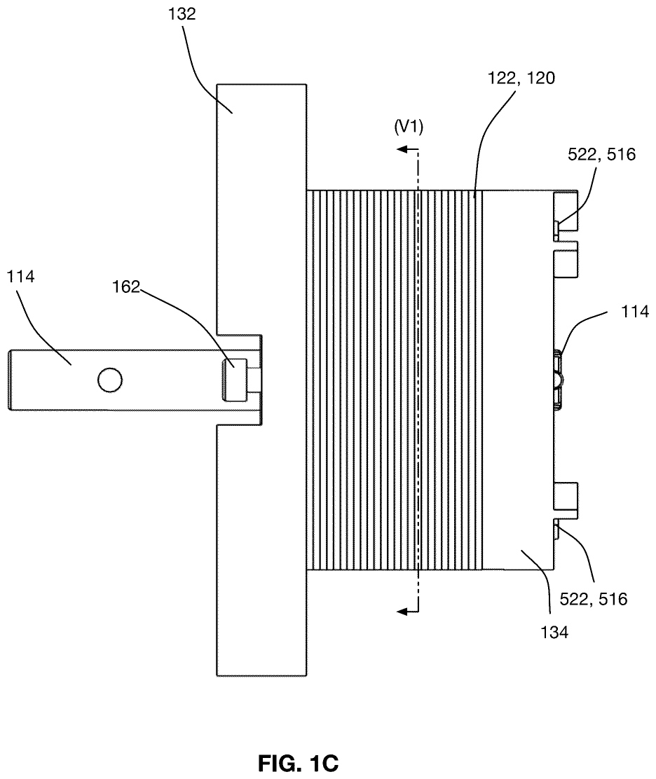

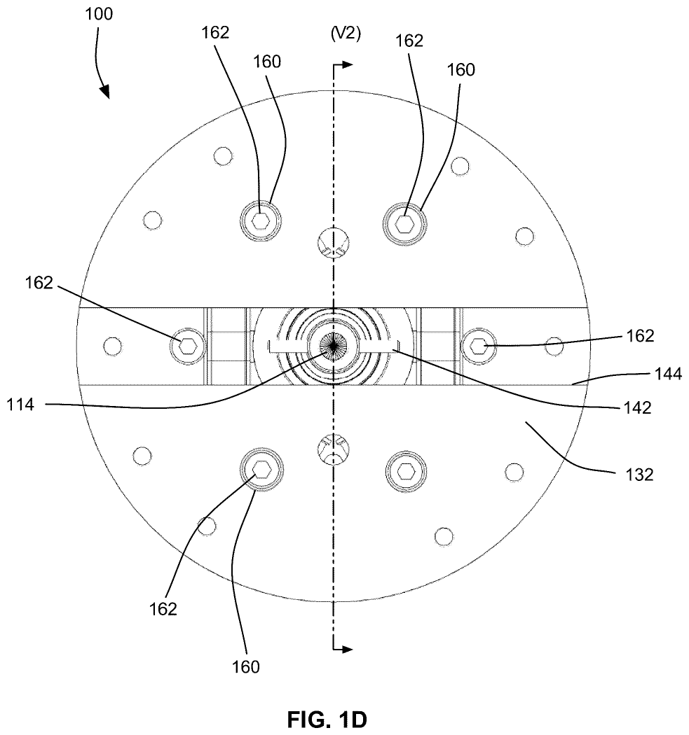

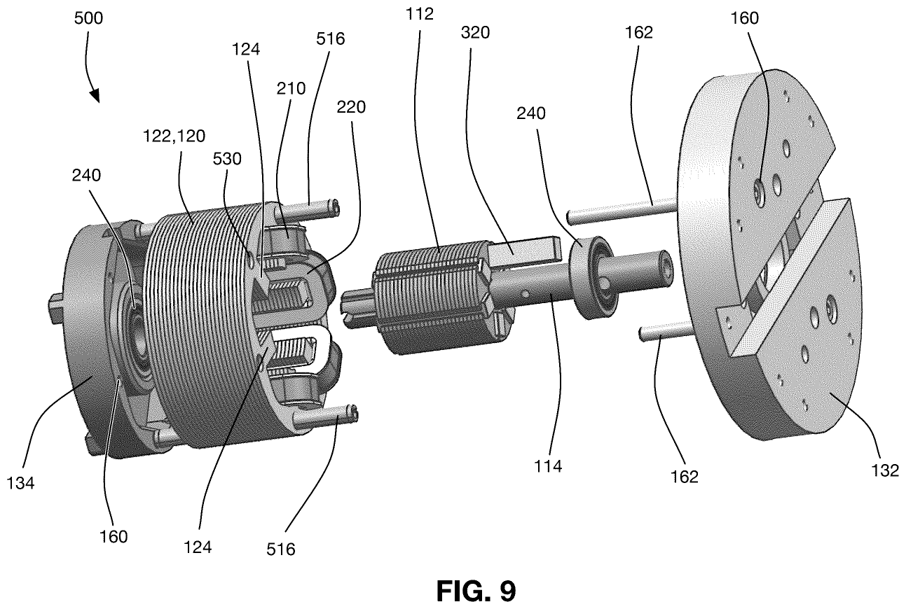

Referring to the embodiments provided in FIGS. 1A to 3 and 9, there is shown a rotary solenoid actuator 100 that includes a rotor assembly 110, a solenoid housing and a stator 120. The rotor assembly 110 includes a rotor body 112 mounted on a rotor shaft 114, the rotor body 112 including a plurality of cavities 310 which extend along a length of the rotor body 112 and which are spaced radially inwards from a radially outer surface of the rotor body 112. Each of the plurality of cavities 310 include a permanent magnet 320 mounted therewithin. The solenoid housing includes opposingly disposed first and second bearing containment assemblies 240, where each of the first and second bearing containment assemblies 240 rotatably support an end of the rotor shaft 114. The stator 120 is positioned to surround at least rotor body 112 of the rotor assembly 110.

### Rotor Assembly:

Referring to FIGS. 1A, 1D, 2, 3, and 9, the rotary solenoid actuator 100 is structured such that the stator 120 is disposed about an outer circumference of the rotor body 112. As provided above, the rotor assembly 110 includes a rotor shaft 114 and a rotor body 112 mounted on the rotor shaft 114. The rotor body 112 has a substantially cylindrical form and can be connected on the rotor shaft 114 through various means, such as through a key and keyway connection. The cylindrical form of the rotor body 112 defines opposing axial end faces and the radially outermost surface of the rotor body 112.

In the specific embodiment provided in FIG. 1A, the rotor shaft 114 includes a pin 142 that extends through therethrough, and a first end housing member 132 includes a channel 144 in which the roll pin 142 of the rotor shaft is disposed.

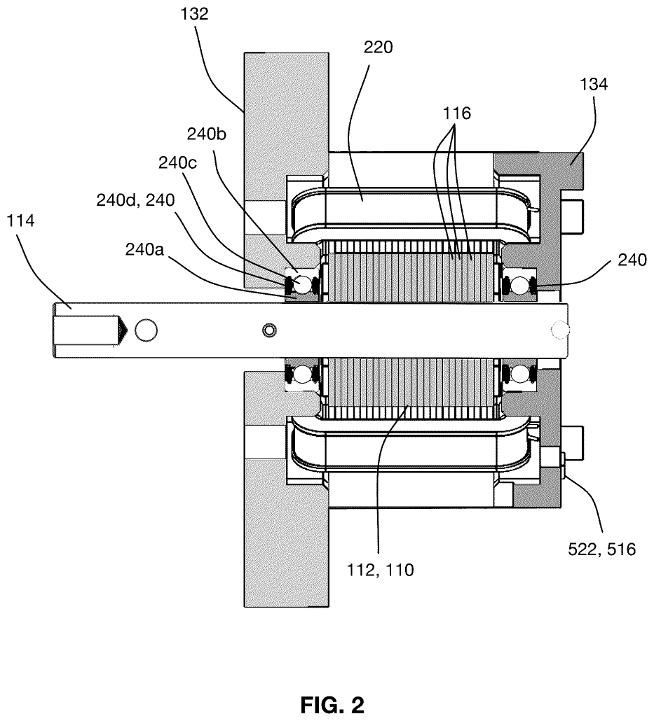

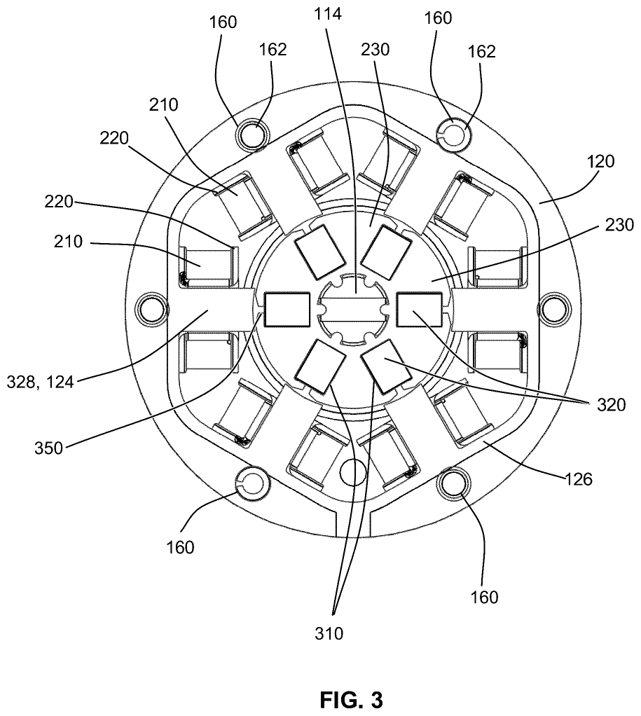

The internal structure of the rotary solenoid actuator 100 is provided in FIGS. 2, 3 and 4, where FIG. 2 shows the section view of the rotary solenoid actuator 100 about the section line (V2) shown in FIG. 1D, and FIG. 3 shows the section view of the rotary solenoid actuator 100 about the section line (V1) shown in FIG. 1C. In the specific embodiment provided in FIG. 3, the internal structures of the rotor body 112 includes a rotor core with a plurality of internal permanent magnets 320. The rotor body 112 includes the plurality of cavities 310 that are spaced inwards from the radially outer surface of the rotor body 112 and which each contain a permanent magnet 320 mounted therewithin. The rotor body 112 also includes a plurality of radially extending poles 230, a central bore and a bore mounting structure. The central bore is sized to receive the rotor shaft 114 therethrough and the bore mounting structure is provided for fixedly mounting the rotor body 112 onto the rotor shaft 114.

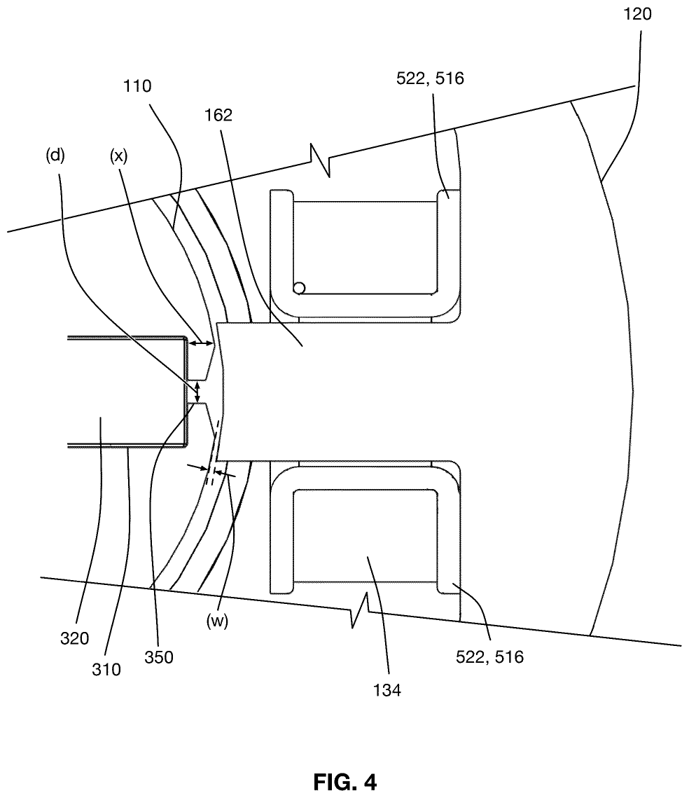

In an embodiment such as provided in FIGS. 3 to 4, the plurality of cavities 310 are regularly spaced apart in an annular or circumferential pattern about a central axis of the rotor body 112. Said another way, the plurality of cavities 310 are provided radially, at equal angular intervals and on the same circumference about the rotor body 112. The plurality of cavities 310 are formed to extend from at least one axial end face of rotor body 112, with spaces between adjacent cavities. The plurality of cavities 310 are formed to have a linear shape and to extend substantially parallel to the central axis, along a length of rotor body 112.

In an exemplary embodiment, the plurality of cavities 310 are bored within the rotor body 112 and each cavity of the plurality of cavities 310 is disposed every 30° in the circumferential direction about the central axis of the rotor body 112. Each of the plurality of cavities 310 has the form of a rectangular prism, with short sides of the prism extending radially along the rotor body 112 and long sides of the prism extending along the length of the rotor body 112. Each of the plurality of cavities 310 is formed with five interior slot faces.

Regarding the specific structure of the permanent magnet 320 mounted within each of the plurality of cavities 310, in an embodiment each permanent magnet 320 is mounted within its respective cavity of the plurality of cavities 310 without any additional fixing means. Said another way, the permanent magnets 320 are mounted within the plurality of cavities without any additional bonding means or adhesive.

In an embodiment, the permanent magnet 320 mounted within each of the plurality of cavities 310 is formed of a magnetic material including at least one of iron, cobalt, samarium, or vanadium.

In an embodiment, each of the permanent magnets 320 is formed to be substantially cuboid, or is shaped as a rectangular prism such that it can be received in a rectangular prism-shaped embodiment of plurality of cavities 310.

In the specific embodiment provided in FIG. 3, each of the permanent magnets 320 has a rectangular cross-section in a plane parallel to the central axis of the rotor body 112. The rectangular cross-section includes pair of short and long sides that are formed such that the long sides are substantially parallel to the central axis of the rotor body 112. The provision of permanent magnets 320 with long axes that are aligned to the central axis of the rotor body is advantageous as the magnetic field lines generated by the permanent magnet 320 are more effectively used in generation of torque between the rotor body 112 and stator 120.

In an embodiment, the two magnetic poles of each of the permanent magnets 320 are defined on opposing surfaces thereof. The opposing surfaces constitute a long side of a rectangle formed by a cross section of the permanent magnet 320 in a direction perpendicular to the central axis of the rotor body 112.

In an embodiment such as shown in FIG. 4, each of the permanent magnets 320 are spaced radially inward from, but provided in the vicinity of, the radially outer surface of the rotor body 112. An embedding distance (x) is defined by the difference between a radius of the radially outermost surface of the rotor body 112 and the radius of a radially outermost surface of each of the plurality of cavities 310.

In an additional embodiment, when the embedding distance (x) for each of the permanent magnets 320 within the rotor body 112 is non-zero, a magnetic force induction region will be generated in the portion of the rotor body 112 that is located between the radially outermost surface of each permanent magnet 320 and the radially outer surface of the rotor body 112. The presence of this magnetic force induction region will lower the input voltage required to drive the motion of the rotary solenoid actuator 100.

In an embodiment, the rotor body 112 is formed as a solid core of a conductive, ferromagnetic material.

In an alternate embodiment such as provided in FIG. 2, the rotor body 112 is formed of a plurality of stacked rotor laminations 116. The plurality of stacked rotor laminations 116 are permanently bonded to one another and have matching cross-sectional forms that collectively define the cross-sectional shape of the rotor body 112.

In an embodiment where the rotor core is formed of the plurality of stacked together rotor laminations 116, each of the rotor laminations 116 is stamped from ferromagnetic material such as cold rolled lamination steel or sheet electrical steel.

In an exemplary embodiment of one such rotor lamination 116 of the plurality of rotor laminations 116, the rotor lamination 116 each include a central bore, a plurality of magnet openings, and a plurality of radially extending projections. Each of the plurality of radially extending projections are formed at circumferentially equal distances about the rotor lamination 116 and are mutually separated by grooves. The plurality of radially extending projections are preferably formed as T-shaped projections with a more narrow, radially inner portion and a wider, radially outer portion. When the plurality of rotor laminations 116 are stacked together, the central bores of each lamination collectively define the central bore through which the rotor shaft 114 extends, and each of the radially extending, T-shaped projections will align with the radially extending, T-shaped projections of the other layers of rotor laminations 116 to collectively form one of the plurality of radially extending poles 230 of the rotor body 112. Like the central bore and the plurality of radially extending projections, the plurality of magnet openings on each rotor laminations 116 will collectively define the plurality of cavities 310 of the rotor body 112 when the plurality of rotor laminations 116 are stacked together.

In an embodiment such as in FIGS. 3 and 4, the rotor body 112 further includes a plurality of slots 350. Each of the plurality of slots 350 corresponds to one of the plurality of cavities 310 and extends between the one of the plurality of cavities 310 and the radially outer surface of the rotor body 112.

In an embodiment, each of the plurality of slots 350 is collectively formed from a plurality of aligned grooves between the T-shaped projections of the plurality of rotor laminations 116. Each groove that separates an adjacent pair of the plurality of radially extending projections on each of the rotor laminations 116 contributes to one of the plurality of slots 350.

In an embodiment provided in FIG. 4, each of the plurality of slots 350 is sized such that the annular width (d) of the slot is less than an annular width of a corresponding cavity of the plurality of cavities 310 such that a portion of the rotor body 112 that extends between adjacent pairs of the plurality of slots 350 and the plurality of cavities 310 is substantially T-shaped. Said another way, each slot is sized such that the length (d) is less than an annular width of the cavity of the plurality of cavities 310 that corresponds to the slot of the plurality of slots 350. In this way, a radially extending pole 230 of the rotor body 112 that extends between two adjacent pairs of the plurality of slots 350 and the plurality of cavities 310 is substantially T-shaped such that the radially extending pole 230 includes a narrower region and a wider region.

In an additional embodiment of the plurality of slots 350 of the rotor body 112, the plurality of slots 350 are sized such that the annular width of each of the plurality of slots 350 is at least two times greater than the difference between an inner diameter of the stator 120 and a diameter of the outer surface of the rotor body 112 ((w) in FIG. 4). Said another way, the annular width of the each slot of the plurality of slots 350 is greater than the annular gap (air gap) between the rotor body 112 and stator 120. By providing a slot with a width (d) that is greater than this annular gap (w), the dielectric resistance of the air within the slot will be greater than the resistance of the air within the annular gap. This difference in resistance will drive the electromagnetic flux generated within the rotor body 112 to flow across the annular gap towards the stator 120 and will limit the electromagnetic flux between adjacent radially extending poles 230, thereby reducing eddy current losses in the rotor body 112.

In the specific embodiment provided in FIGS. 4, each of the plurality of slots 350 has a substantially rectangular form and extends along the length of the rotor body 112. In this specific embodiment, each of the plurality of slots 350 is collectively formed by a groove from each of the plurality of stacked rotor laminations 116. Each groove on each rotor lamination 116 is formed with an annular width (d) that defines the annular width d of each slot 350 of the plurality of slots 350.

In an embodiment, the plurality of cavities 310 are formed in the rotor body 112 such that the plurality of stacked rotor laminations 116 collectively form a plurality of stacked teeth on at least one inner surface of each of the plurality of cavities 310. Each lamination of the plurality of stacked rotor laminations 116 serves as one of the “stacked teeth” on the at least one inner surface of each of the plurality of cavities 310. The plurality of stacked teeth on the at least one inner surface frictionally engage a surface of the permanent magnet 320 mounted in each of the plurality of cavities 310 such that each permanent magnet 320 is retained in its respective cavity 310.

In an additional embodiment, the plurality of stacked teeth on the at least one inner surface of each of the plurality of cavities 310 extend circumferentially about their respective cavities.

### Stator:

In an embodiment, the stator 120 includes opposing first and second stator end faces, a stator core 120a that defines a radially outer surface of the stator 120, a stator insert 126, and a plurality of stator poles 124. Each of the first and second stator end faces are comprised of end faces of each of the stator poles and an end face of the stator core 120a. Each of the plurality of stator poles 124 is diametrically opposed to another of the plurality of stator poles 124, and the plurality of stator poles 124 are evenly spaced about a central axis of the stator 120. In the specific example provided in FIG. 3, the stator 120 the plurality of stator poles 124 are a plurality of inwardly extending poles 328, where a radially innermost diameter of the plurality of inwardly extending poles 328 defines an inner diameter of the stator 120.

In an embodiment, the number of permanent magnets 320 (and therefore the number of the plurality of cavities 310) provided in the rotor body 112 is set proportional to the number of the plurality of stator poles 124. Said another way, the greater the number of the plurality of stator poles 124, the greater the number of permanent magnets 320 that are mounted within the rotor body 112.

In an embodiment where the stator 120 is provided with plurality of inwardly extending poles 328, the plurality of inwardly extending poles 328 extend radially inwards to define a radially innermost surface of the stator core 120a. In an embodiment such as shown in FIGS. 2, 3 and 4, each of the plurality of inwardly extending poles 328 of the stator 120 includes a winding mount 220 that is mounted around a circumference of the pole 328, and a set of windings 210 that are wound about the winding mounts 220 of each of the plurality of inwardly extending poles 328. In the specific embodiment provided in FIGS. 3 and 4, the set of windings 210 is a set of three-phase, single-tooth windings. Each single-tooth winding of the set of windings 210 is wound around just one of the winding mounts 220 such that each winding of the set of windings 210 is associated within only one of the inwardly extending poles 328. Each winding of the set of windings 210 is connected to a terminal of a commutator that is provided within the rotary solenoid actuator 100.

In an embodiment, one of the stator core 120a, the radially innermost surface of the stator 120, or a radially outermost surface of the stator 120 may be coated with an insulating material such as laminates composed of vulcanized fiber, polyester films and polyester mats and molded components of glass filled nylons, polyesters and polybutylene terephthalates fitted to winding slots before the set of windings 210 are wound about each respective winding mount 220 of the inwardly extending poles 328 of the stator 120.

In an embodiment, the stator 120 is an annular stator 120 that is formed as an annular, solid body of ferromagnetic material.

In an alternate embodiment such as provided in FIG. 1A to 2, the stator 120 is formed of a plurality of stacked-together stator laminations 122. Each of the plurality of stator laminations 122 is stamped from ferromagnetic material such as cold rolled motor lamination steel or sheet electrical steel.

In an embodiment, each of the plurality of stacked rotor laminations 116 and plurality of stacked stator laminations 122 are internally insulated.

### Solenoid Housing:

As provided above, each of the first and second end housing members 132, 134 include bearing containment assemblies 240 that rotatably supports opposing ends of the rotor shaft 114. In the specific embodiment provided in FIG. 2, each of the bearing containment assemblies 240 is a ball bearing assembly that includes an inner race 240a that surrounds and directly contacts the rotor shaft 114, a plurality of ball bearings 240c, a bearing cage 240d to secure the bearing positions and an outer race 240b that shields the bearings 240c and cage 240d. While this specific embodiment provides the bearing containment assemblies 240 as ball bearings, various other bearing types such as roller bearings or plain bearings can be suitably employed as the bearing containment assemblies 240 of the rotary solenoid actuator 100.

In an embodiment such as the embodiment provided in FIGS. 1A to 1C, 2, and 5A to 5D, the solenoid housing includes first and second end housing members 132, 134. The first and second end housing members 132, 134 are preferably formed of a ferromagnetic material.

The rotary solenoid actuator 100 may alternatively or additionally be structured to provide and maintain a substantially concentric alignment of the rotor and the stator 120 such that a minute air gap is achieved between the rotor and stator 120.

In an embodiment, the rotary solenoid actuator 100 includes the at least one securing element 162 that is connected to the stator 120 and that extends between the first and second end housing members 132, 134 for axially securing the stator 120 between the first and second end housing members 132, 134. The stator 120 includes at least one receiving aperture 160 that is formed along a length thereof for receiving the at least one securing element 162.

In the specific embodiment provided in FIG. 1A, the at least one securing element 162 is a pair of securing screws and the at least one receiving aperture 160 is a pair of clearance holes that extend along the length of the stator 120. Each of the pair of securing screws extend between the first and second end plates and are received through one of the pair of clearance holes. The pair of securing screws are secured within the clearance holes to axially secure all the components of the rotary solenoid actuator 100 between the first and second end plates.

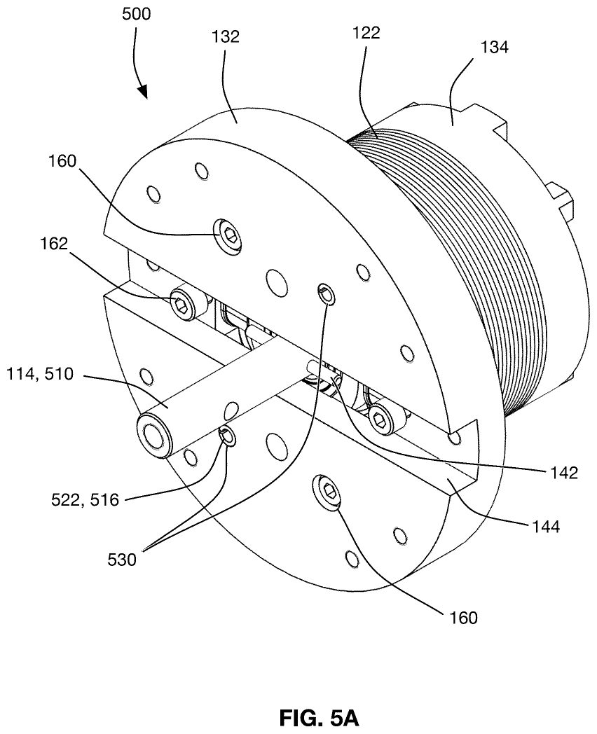

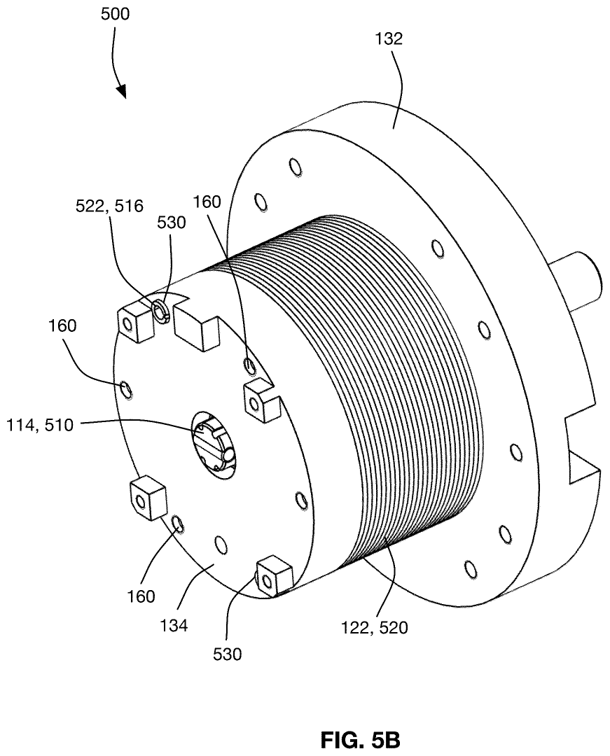

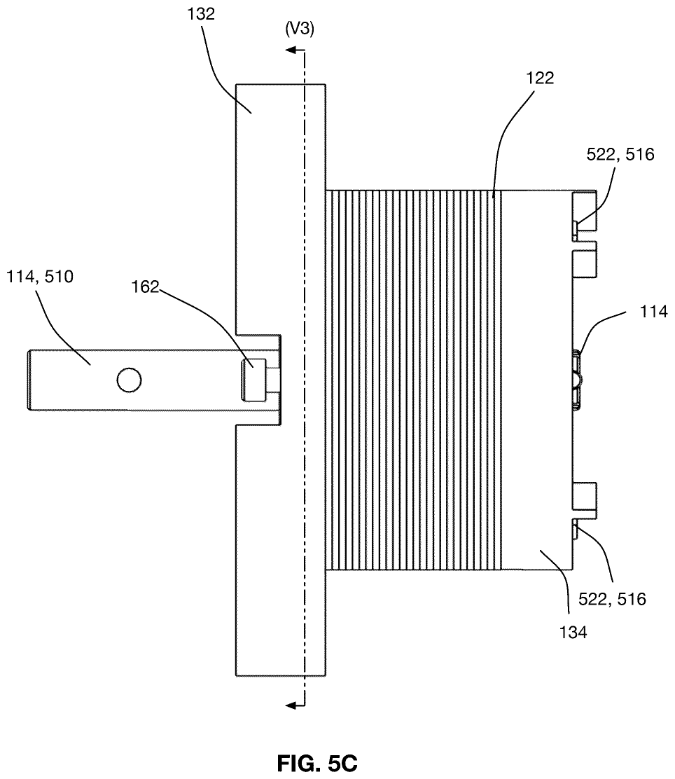

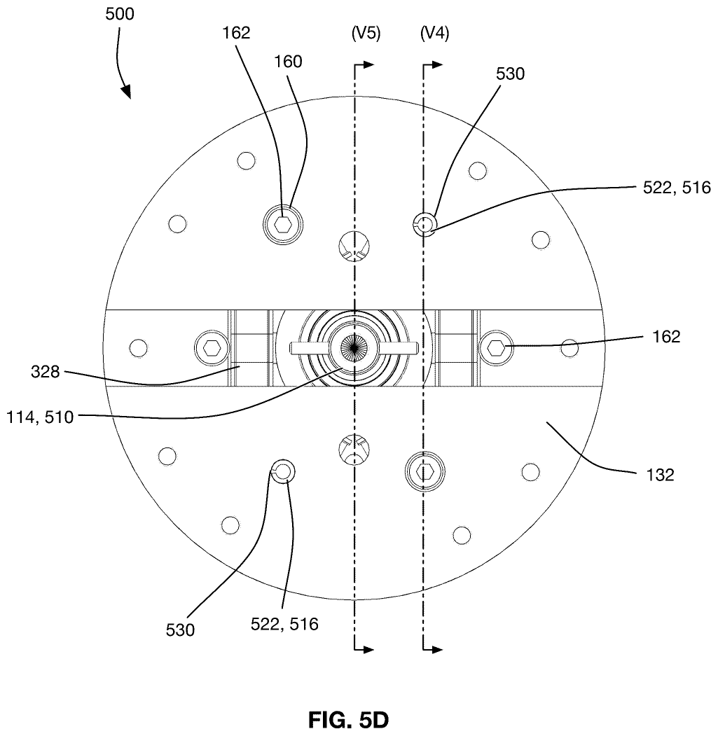

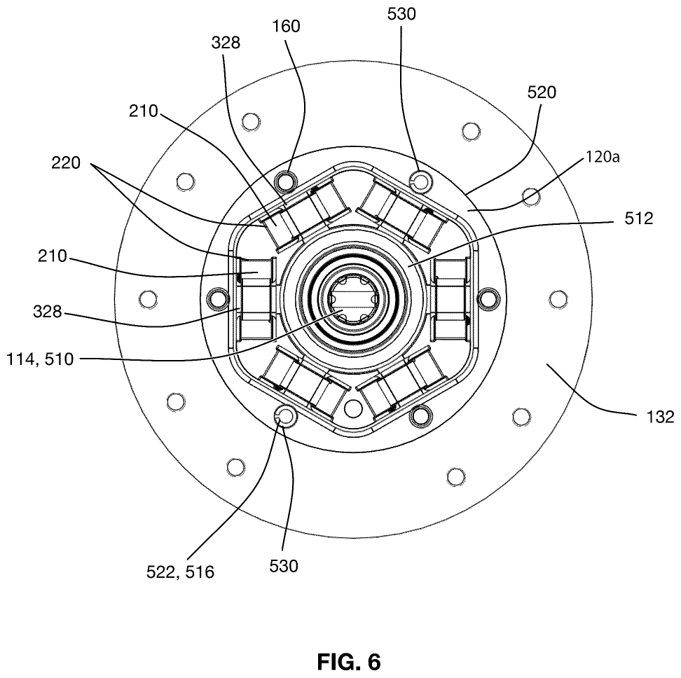

In an embodiment such as provided in FIGS. 5A to 6, the rotary solenoid actuator 500 includes a rotor assembly 510 including a rotor body 512 mounted on a rotor shaft 114, a solenoid housing including first and second end housing members 132, 134, where each of the first and second end housing members 132, 134 including a bearing containment assembly that rotatably supports an end of the rotor shaft 114, and a stator 520 that surrounds the rotor assembly 510 and including a plurality of through-apertures 530 extending along a length thereof. The rotary solenoid actuator 500 also includes at least one securing element 162 that is connected to the stator 520 and that extends between the first and second end housing members 132, 134 for axially securing the stator 520 between the first and second end housing members 132, 134, and a plurality of alignment elements 516. In this embodiment, each of the plurality of alignment elements 516 are received through one of the plurality of through-apertures 530 and are connected to each of the first and second housing members 132, 134. The plurality of through-apertures 530 are formed such that when stator 520 is axially secured between the first and second housing members 132, 134 and the plurality of alignment elements 516 are received through the plurality of through-apertures 530, the stator 520 is secured in concentric alignment with the rotor body 512 and the first and second housing members 132, 134.

In some embodiments of the rotary solenoid actuator 500 such as shown in FIGS. 5A to 5C, the stator 520 includes all the characteristics, elements, and features of the above-described stator 120.

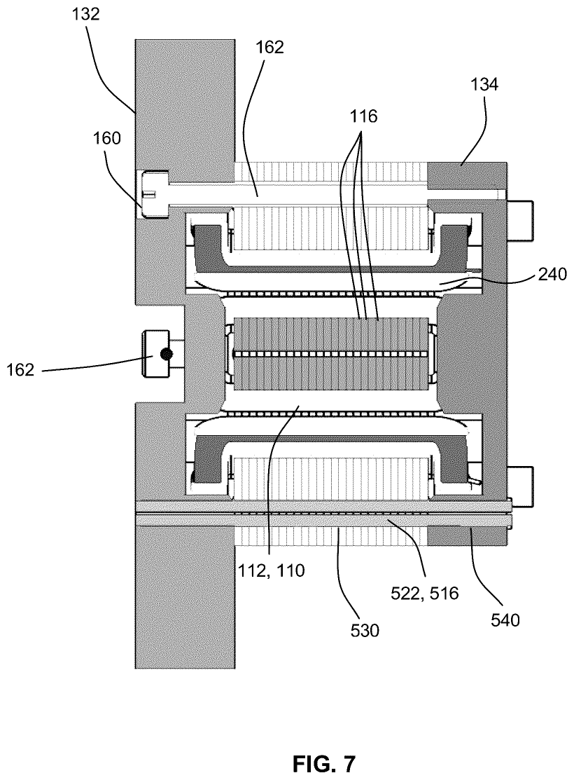

In some embodiment of the rotary solenoid actuator 500, the rotor assembly 510, and the rotor body 512 include all the characteristics, elements, and features of the above-described rotor assembly 110 and rotor body 112, respectively. Said another way, in some embodiments of the present disclosure, the rotor assembly 510 and the rotor body 512 are the same as the rotor assembly 110 and the rotor body 112. Such an embodiment of the rotary solenoid actuator 100 is provided in FIG. 7, where the rotary solenoid actuator 100 includes the rotor assembly 110 and the rotor body 112 mounted on the rotor shaft 114. The rotor body 112 includes the plurality of cavities 310 and the permanent magnets 320 mounted within each of the plurality of cavities 310, and the stator 120 includes the plurality of through-apertures 530 that receive the plurality of alignment elements 516.

As provided previously, the solenoid housing includes the first and second end housing members 132, 134, and each of the first and second end housing members 132, 134 include one of the bearing containment assemblies 240 that rotatably supports an end of the rotor shaft 114.

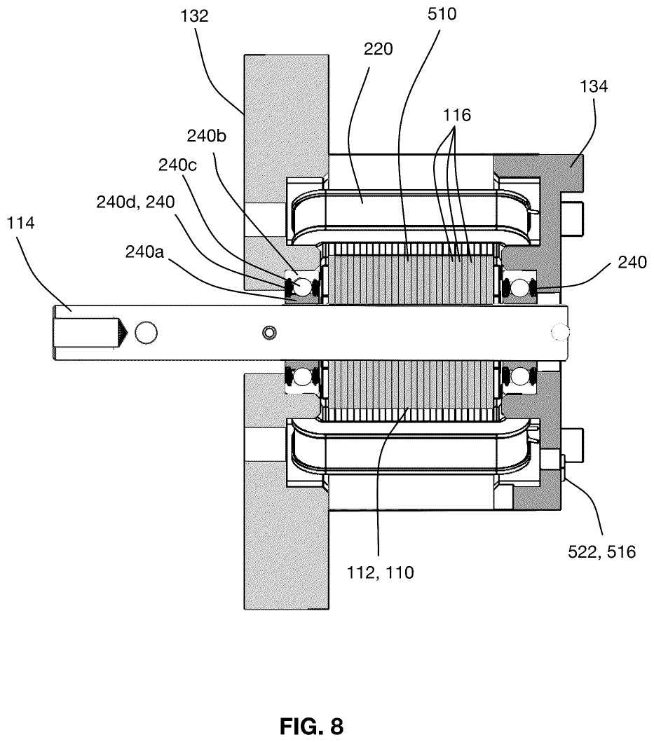

In an embodiment, the first and second end housing members 132, 134 are formed as disk-shaped first and second end plates. In the specific embodiment provided in FIGS. 5A to 8, the first and second end housing members 132, 134 are the first and second end plates. Each of the first and second end plates has a disk-shaped form, a central through-bore, and an annular groove in which the bearing containment assembly 240 is mounted. The through-bores of the first and second end plates are sized such that the rotor shaft 114 can be disposed through the solenoid housing. The stator 520 includes the plurality of through-apertures 530 that extend along a length of the stator 520 and that receive the plurality of alignment elements 516. As provided above, the plurality of through-apertures 530 are formed such that when stator 520 is axially secured between the first and second end plates and the plurality of alignment elements 516 are received through the plurality of through-apertures 530, the stator 520 is secured in concentric alignment with the rotor body 512 and the first and second housing members 132, 134.

### Alignment Elements:

As provided above, the rotary solenoid actuator 500 includes the plurality of alignment elements 516, where each of the plurality of alignment elements 516 are received through one of the plurality of through-apertures 530 and are connected to each of the first and second housing members 132, 134 for securing the stator 120 in concentric alignment with the rotor body 512 and the first and second housing members 132, 134.

In an embodiment such as provided in FIGS. 5A to 5D, 6 and 7, the plurality of alignment elements 516 are a plurality of alignment pins 522. Each of the first and second end housing members 132, 134 include a plurality of mounting recesses 540 that correspond to the plurality of alignment pins 522. Each mounting recess 540 of the plurality of mounting recesses 540 is formed to retain an end of one of the plurality of alignment pins 522.

In an embodiment, the plurality of alignment pins 522 are connected to each of the first and second end housing members 132, 134 such that the plurality of alignment pins 522 are removably retained in a plurality of mounting recesses 540 of the first end housing member 132 and are removably retained in a plurality of mounting recesses 540 of the second end housing member 134.

In the specific embodiment provided in FIGS. 5A to 5D, 6, 7, and 8, the mounting recesses 540 extend though both the first and second end housing members 132, 134.

In an additional embodiment where the plurality of alignment elements 516 are the plurality of alignment pins 522, the plurality of alignment pins 522 are a plurality of spring pins. The plurality of spring pins can be a plurality of slotted spring pins or a plurality of coiled spring pins.

In an embodiment where the plurality of alignment elements 516 are a plurality of spring pins, the plurality of through-apertures 530 and plurality of spring pins are relatively sized such that when the plurality of spring pins are received in the plurality of through-apertures 530, each of the plurality of spring pins is press fit within one of the plurality of through-apertures 530. The plurality of mounting recesses 540 are also sized relative to the plurality of spring pins such that when the first and second end housing members 132, 134 are mounted on either side of the stator 520 and the ends of the plurality of spring pins are removably retained in the plurality of mounting recesses 540 of each of the first and second end housing members 132, 134, each spring pin is press fit within one of the plurality of mounting recesses 540 on each of the first and second end housing members 132, 134.

In an embodiment where the plurality of alignment elements 516 are a plurality of spring pins, the locating of the bearing assemblies 240 to the stator pole faces is such that the spring pins are received within the plurality of through-apertures 530 via a slight press fit such that there is no motion due to tolerance clearance. The locating of bearing assemblies 240 to stator 120 face poles precludes normally required feature clearance between internal connecting parts of solenoid, such as nubs and holes or screws and holes.

In the exemplary embodiment provided in FIG. 7, a section-view of the rotary solenoid actuator 500 is provided along the section-line (V4) shown in FIG. 5D. In this embodiment, each of the plurality of mounting recesses 540 formed in both the first and second end housing members 132, 134 extend through the entirety of the first and second end housing members 132, 134, and are sized to receive the spring pins (alignment pins 522) through a press fit.

In an embodiment, the application of press-fit spring pins as the plurality of alignment elements 516 offers a benefit to the functioning of the rotary solenoid actuator 500, as the spring pins will absorb machining tolerance in the final assembly of the rotary solenoid actuator 500, further improving the concentricity of the rotor assembly 510 and stator 520.

In an embodiment, the plurality of alignment elements 516, plurality of through-apertures 530 and the plurality of mounting recesses 540 are relatively sized and positioned such that the bearing containment assemblies 240 locate to the stator 520 pole faces (axial end faces of the poles of the stator 520). The bearing containment assemblies 240 locate to the stator 520 pole faces such that the rotor body 512 and the rotor assembly 510 are substantially concentric with the stator 520. The provision of a high degree of concentricity between the rotor body 512 and stator 520 ensures the ability of the rotary solenoid actuator 500 to maintain a small air gap.

### Through-Apertures

In an embodiment, the plurality of through-apertures 530 extend along an axial length of the stator 520 defined by the central axis of the stator 520. The plurality of through-apertures 530 extend between the first and second end faces of the stator 520 and are specifically disposed on portions of the portion of the axial end faces of the stator 520 that are formed of the stator core 120a.

In the specific embodiment provided in FIG. 5A to 5D, the plurality of through-apertures 530 are formed as circular through-bores. Each of the circular through-bores extends between the end faces of the stator 520, along the axial length of the stator 520.

In an additional embodiment where the plurality of stator poles of the stator 520 are the plurality of inwardly extending poles 328 as presented above, each of the plurality of through-apertures 530 is formed on the stator 520 so as to be on the stator core 120a and to be radially aligned with one of the plurality of inwardly extending poles 328. Said another way, the plurality of through-apertures 530 are provided at the intersection of the plurality of inwardly extending poles 328 and the stator core 120a.

By providing each of the plurality of apertures in radial alignment with one of the inwardly extending poles 328, the eddy current losses in the assembled rotor and stator 520 are reduced. As a current is applied to the assembled stator 520, the magnetic flux generated within the stator 520 will flow radially outwards, down the length of each of the inwardly extending poles 328. At the intersection of the inwardly extending poles 328 and the stator core 120a (which is positioned radially outside of the plurality of inwardly extending poles), the magnetic flux will bidirectionally split and flow in opposing directions along the stator core 120a. At more radially outward sections of each intersection of the inwardly extending poles 328 and the stator core 120a, the flux magnitude will be lower compared to other sections of the stator core 120a. Positioning at least one of the through-apertures 530 at intersections of the inwardly extending poles 328 and the stator core 120a will reduce the disruptive effect of the through-apertures 530 on the flow of the magnetic flux, thereby reducing the formation of eddy current and reduce flux losses within the stator 520. Positioning at least one of the through-apertures 530 at a radially outward section of an intersection of the stator core 120a and inwardly extending poles 328 will further reduce the disruptive effect of the through-apertures 530 on the flow of the magnetic flux through the stator 520.

In the specific embodiment provided in FIG. 6, each of the plurality of through-apertures 530 are disposed along the end faces of the stator core 120a such that a centre-point of each through-aperture 530 is radially aligned with a long axis of one of the plurality of inwardly extending poles 328. In this embodiment, each of the through-apertures 530 corresponds to one of the plurality of inwardly extending poles 328 such that the number of through-apertures 530 is equivalent to the number of poles.

In an alternate embodiment, the number of through-apertures 530 is different from the number of inwardly extending poles 328.

### Securing Elements:

In an embodiment, like the rotary solenoid actuator 100, the rotary solenoid actuator 500 includes at least one securing element 162 that is connected to the stator 520 and that extends between the first and second end housing members 132, 134 for axially securing the stator 520 between the first and second end housing members 132, 134.

In an additional embodiment, the stator 520 includes at least one receiving aperture 160 that is formed along a length thereof for receiving the at least one securing element 162. The at least one securing element 162 extends between the first and second end housing members 132, 134, and is connected through the at least one receiving aperture 160 which is formed along a length of the stator 520.

In the specific embodiment provided in FIGS. 5D and 7, the at least one securing element 162 is a set of securing nuts and the at least one receiving aperture 160 is a set of threaded mounting holes that extends along the length of the stator 520. Each of the set of securing nuts extend between the first and second end plates and are received through one of the set of threaded mounting holes. The set of securing nuts are secured within the threaded mounting holes to axially secure all the components of the rotary solenoid actuator 500 between the first and second end plates.

In an embodiment where the rotor body 512 and stator 520 are formed from the respective plurality of rotor laminations 116 and plurality of stator laminations 122, the mounting of the permanent magnets 320 within the interior of the rotor body 512 and the provision of the alignment elements 516 and through-apertures 530 within the rotary solenoid actuator 500 provide for improved, tighter tolerances on the resulting rotary solenoid actuator 500. These improved tolerances provide for a smaller air gap than is achievable with exterior-mounted permanent motors. In this embodiment, the tolerances of the rotor body 512 and stator 520 are dictated by the tolerances of the processes used in producing the rotor and stator laminations 122 (typically a punching or stamping process) rather than the tolerances for the processes used in forming the permanent magnets 320.

In an exemplary embodiment, a standard tolerance for the permanent magnets 320 is ±0.1 mm, and a minimum standard tolerance for the rotor and stator laminations 116, 122 is ±0.025 mm. Applying the tolerance (±0.025) of the rotor and stator laminations 122 to all dimensions of the rotary solenoid actuator 500 including the inner diameter of the stator 520, diameter of the radially outer surface of the rotor body 512, through-apertures 530 of the stator 520 and bearing containment assemblies 240, and considering the concentricity, the greatest variation of the air gap would be ±0.12 mm. As such, in this exemplary embodiment, the rotary solenoid actuator 500 can achieve a minimum air gap of 0.13 mm.

The above-described embodiments are intended to be examples of the present disclosure and alterations and modifications may be affected thereto, by those of skill in the art, without departing from the scope of the disclosure that is defined solely by the claims appended hereto.

### PART LIST

100 rotary solenoid actuator
110 rotor assembly
112 rotor body
114 rotor shaft
116 rotor laminations
120 stator
120a stator core
122 stator laminations
124 stator poles
126 stator insert
132 first end housing member
134 second end housing member
142 roll pin
144 channel
160 receiving apertures
162 securing elements
210 set of windings
220 winding mount
230 radially extending poles
240 first and second bearing containment assemblies
310 plurality of cavities
320 permanent magnet
328 inwardly extending poles
350 slots
500 rotary solenoid actuator
510 rotor assembly
512 rotor body
516 alignment elements
520 stator
522 alignment pins
530 through-apertures
540 mounting recess

1. A rotary solenoid actuator comprising:
a rotor assembly including a rotor body mounted on a rotor shaft;
a solenoid housing including first and second end housing members, each of the first and second end housing members including a bearing containment assembly that rotatably supports an end of the rotor shaft;
a stator surrounding the rotor assembly and including a plurality of through-apertures extending along a length thereof;
at least one securing element being connected to the stator and extending between the first and second end housing members for axially securing the stator between the first and second end housing members; and
a plurality of alignment elements, each of the plurality of alignment elements being received through one of the plurality of through-apertures and being connected to each of the first and second end housing members, the plurality of through-apertures being formed such that when stator is axially secured between the first and second end housing members and the plurality of alignment elements are received through the plurality of through-apertures, the stator is secured in concentric alignment with rotor body and the first and second housing members.

2. The rotary solenoid actuator according to claim 1, wherein the stator is formed such that when the stator is axially secured between the first and second end housing members, opposing end faces of the stator locate to the bearing containment assemblies of each of the first and second end housing members.

3. The rotary solenoid actuator according to claim 1, wherein the plurality of alignment elements are a plurality of alignment pins.

4. The rotary solenoid actuator according to claim 3, wherein the plurality of alignment pins are a plurality of spring pins.

5. The rotary solenoid actuator according to claim 4, wherein the plurality of through-apertures and plurality of spring pins are relatively sized such that when the plurality of spring pins are received in the plurality of through-apertures, each of the plurality of spring pins is press fit within one of the plurality of through-apertures.

6. The rotary solenoid actuator according to claim 3, wherein each of the first and second end housing members include a plurality of mounting recesses that correspond to the plurality of alignment pins; and wherein each mounting recess of the plurality of mounting recesses is formed to retain an end of one of the plurality of alignment pins.

7. The rotary solenoid actuator according to claim 3, wherein the plurality of alignment pins are connected to each of the first and second end faces such that the plurality of alignment pins are removably retained in a plurality of mounting recesses of the first end housing member and are removably retained in a plurality of mounting recesses of the second end housing member.

8. The rotary solenoid actuator according to claim 1, wherein the stator includes a plurality of inwardly extending poles; and wherein each of the plurality of through-apertures is formed on the stator so as to be radially aligned with one of the plurality of inwardly extending poles.

9. The rotary solenoid actuator according to claim 8, wherein a radially innermost diameter of the plurality of inwardly extending poles defines an inner diameter of the stator.

10. The rotary solenoid actuator according to claim 1, wherein the at least one securing element extends between the first and second end housing members and is connected through a receiving apertures formed along a length of the stator.
